(19) United States
(12) Patent Application Publication
(10) Pub. No.: US 2021/0249879 A1
(43) Pub. Date: Aug. 12, 2021

(54) WIRELESS CHARGER FOR A CONTAINER

(71) Applicant: AIRA, INC., Chandler, AZ (US)

(72) Inventors: Eric Heindel Goodchild, Phoenix, AZ (US); Jake Slatnick, San Diego, CA (US)

(21) Appl. No.: 17/168,165

(22) Filed: Feb. 4, 2021

Related U.S. Application Data
(60) Provisional application No. 62/971,211, filed on Feb. 6, 2020.
(60) Provisional application No. 62/977,407, filed on Feb. 16, 2020.
(60) Provisional application No. 63/066,223, filed on Aug. 15, 2020.

(51) Int. Cl. H02J 7/00; H02J 50/12; H02J 50/40; H02J 50/00; H02J 50/80; H02J 7/02

(52) U.S. Cl. CPC H02J 7/0042; H02J 50/12; H02J 50/402; H02J 7/02; H02J 50/80; H02J 7/00032; H02J 50/005

(57) ABSTRACT

Systems, methods and apparatus for wireless charging are disclosed. A charging apparatus has a first printed circuit board configured to be mounted proximate to a wall of a container that provides a partially-enclosed interior and one or more transmitting coils arranged on at least one surface of the first printed circuit board and configured to generate an electromagnetic flux within the partially-enclosed interior in response to a charging current received from a controller. The charging current may be received when a chargeable device has been placed within the partially-enclosed interior.

### PRIORITY CLAIM

This application claims priority to and the benefit of provisional patent application No. 62/971,211 filed in the United States Patent Office on Feb. 6, 2020, of provisional patent application No. 62/977,407 which was filed in the United States Patent Office on Feb. 16, 2020 and of provisional patent application No. 63/066,223 filed in the United States Patent Office on Aug. 15, 2020, the entire content of these applications being incorporated herein by reference as if fully set forth below in their entirety and for all applicable purposes.

### TECHNICAL FIELD

The present invention relates generally to wireless charging of batteries, including batteries in mobile computing devices.

### BACKGROUND

Wireless charging systems have been deployed to enable certain types of devices to charge internal batteries without the use of a physical charging connection. Devices that can take advantage of wireless charging include mobile processing and/or communication devices. Standards, such as the Qi standard defined by the Wireless Power Consortium enable devices manufactured by a first supplier to be wirelessly charged using a charger manufactured by a second supplier. Standards for wireless charging are optimized for relatively simple configurations of devices and tend to provide basic charging capabilities.

Improvements in wireless charging capabilities are required to support continually increasing complexity of mobile devices and changing form factors. For example, there is a need for a faster, lower power detection techniques and charging surfaces that accommodate the changing form factors of chargeable devices.

### BRIEF DESCRIPTION OF THE DRAWINGS

FIG. 1 illustrates an example of a charging cell that may be employed to provide a charging surface in accordance with certain aspects disclosed herein.

FIG. 2 illustrates an example of an arrangement of charging cells provided on a single layer of a segment of a charging surface that may be adapted in accordance with certain aspects disclosed herein.

FIG. 3 illustrates an example of an arrangement of charging cells when multiple layers are overlaid within a segment of a charging surface that may be adapted in accordance with certain aspects disclosed herein.

FIG. 4 illustrates the arrangement of power transfer areas provided by a charging surface that employs multiple layers of charging cells configured in accordance with certain aspects disclosed herein.

FIG. 5 illustrates a wireless transmitter that may be provided in a charger base station in accordance with certain aspects disclosed herein.

FIG. 6 illustrates a first topology that supports matrix multiplexing switching for use in a wireless charger adapted in accordance with certain aspects disclosed herein.

FIG. 7 illustrates a second topology that supports direct current drive in a wireless charger adapted in accordance with certain aspects disclosed herein.

FIG. 8 illustrates first configurations of a charging surface and chargeable device in accordance with certain aspects disclosed herein.

FIG. 9 illustrates second charging configurations on a charging surface when a chargeable device is being charged in accordance with certain aspects disclosed herein.

FIG. 10 illustrates a charging surface of a multi-device wireless charger provided in accordance with certain aspects disclosed herein.

FIG. 11 illustrates a charging system that may be provided in a container in accordance with certain aspects disclosed herein.

FIG. 12 illustrates a charging apparatus that may be inserted in a container in accordance with certain aspects disclosed herein.

FIG. 13 illustrates an example of a wireless charging system that provides or operates a distributed charging surface in accordance with certain aspects disclosed herein.

FIG. 14 illustrates an example of a charging system that includes multiple charging devices provided in accordance with certain aspects of this disclosure.

FIG. 15 illustrates a first example of a combined control circuit in a modular charging surface provided in accordance with certain aspects disclosed herein.

FIG. 16 illustrates a second example of a combined control circuit that may be provided in a modular charging surface provided according to certain aspects disclosed herein.

FIG. 17 is flowchart illustrating one example of a method for charging an apparatus placed in a container adapted in accordance with certain aspects disclosed herein.

FIG. 18 illustrates one example of an apparatus employing a processing circuit that may be adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of wireless charging systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a processor-readable storage medium. A processor-readable storage medium, which may also be referred to herein as a computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), Near Field Communications (NFC) token, random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

### Overview

Certain aspects of the present disclosure relate to systems, apparatus and methods associated with wireless charging devices that provide a free-positioning charging surface using multiple transmitting coils or that can concurrently charge multiple receiving devices. In one aspect, a controller in the wireless charging device can locate a device to be charged and can configure one or more transmitting coils optimally positioned to deliver power to the receiving device. Charging cells may be provisioned or configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

Certain aspects disclosed herein relate to improved wireless charging systems. Systems, apparatus and methods are disclosed that accommodate free placement of chargeable devices on one or more surfaces provided by a charging system constructed from modular surface elements. In one example, a single surface provided by the charging system is formed from a configuration of multiple modular multi-coil wireless charging elements. In another example, a distributed charging surface may be provided by the charging system using multiple interconnected multi-coil wireless charging elements.

Certain aspects can improve the efficiency and capacity of a wireless power transmission to a receiving device. In one example, a wireless charging device has a battery charging power source, a plurality of charging cells configured in a matrix, a first plurality of switches in which each switch is configured to couple a row of coils in the matrix to a first terminal of the battery charging power source, and a second plurality of switches in which each switch is configured to couple a column of coils in the matrix to a second terminal of the battery charging power source. Each charging cell in the plurality of charging cells may include one or more coils surrounding a power transfer area. The plurality of charging cells may be arranged adjacent to a charging surface without overlap of power transfer areas of the charging cells in the plurality of charging cells.

In certain aspects, a charging apparatus has a first printed circuit board configured to be mounted proximate to a wall of a container that provides a partially-enclosed interior and one or more transmitting coils arranged on at least one surface of the first printed circuit board and configured to generate an electromagnetic flux within the partially-enclosed interior in response to a charging current received from a controller. The charging current may be received when a chargeable device has been placed within the partially-enclosed interior

According to certain aspects disclosed herein, power can be wirelessly transferred to a receiving device located anywhere on a charging surface that can have an arbitrarily defined size and/or shape without regard to any discrete placement locations enabled for charging. Multiple devices can be simultaneously charged on a single charging surface.

### Charging Cells

Certain aspects of the present disclosure relate to systems, apparatus and methods applicable to wireless charging devices that provide a free-positioning charging surface that has multiple transmitting coils or that can concurrently charge multiple receiving devices. In one aspect, a processing circuit coupled to the free-positioning charging surface can be configured to locate a device to be charged and can select and configure one or more power transmitting coils that are optimally positioned to deliver power to the receiving device. Charging cells may be configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

According to certain aspects disclosed herein, a charging surface in a wireless charging device may be provided using charging cells that are deployed adjacent to a surface of the charging device. In one example the charging cells are deployed in accordance with a honeycomb packaging configuration. A charging cell may be implemented using one or more coils that can each induce a magnetic field along an axis that is substantially orthogonal to the charging surface adjacent to the coil. In this disclosure, a charging cell may refer to an element having one or more coils where each coil is configured to produce an electromagnetic field that is additive with respect to the fields produced by other coils in the charging cell and directed along or proximate to a common axis. In this description, a coil in a charging cell may be referred to as a charging coil or a transmitting coil.

In some examples, a charging cell includes coils that are stacked along a common axis. One or more coils may overlap such that they contribute to an induced magnetic field substantially orthogonal to the charging surface. In some examples, a charging cell includes coils that are arranged within a defined portion of the charging surface and that contribute to an induced magnetic field within the defined portion of the charging surface, the magnetic field contributing to a magnetic flux flowing substantially orthogonal to the charging surface. In some implementations, charging cells may be configurable by providing an activating current to coils that are included in a dynamically-defined charging cell. For example, a wireless charging device may include multiple stacks of coils deployed across a charging surface, and the wireless charging device may detect the location of a device to be charged and may select some combination of stacks of coils to provide a charging cell adjacent to the device to be charged. In some instances, a charging cell may include, or be characterized as a single coil. However, it should be appreciated that a charging cell may include multiple stacked coils and/or multiple adjacent coils or stacks of coils.

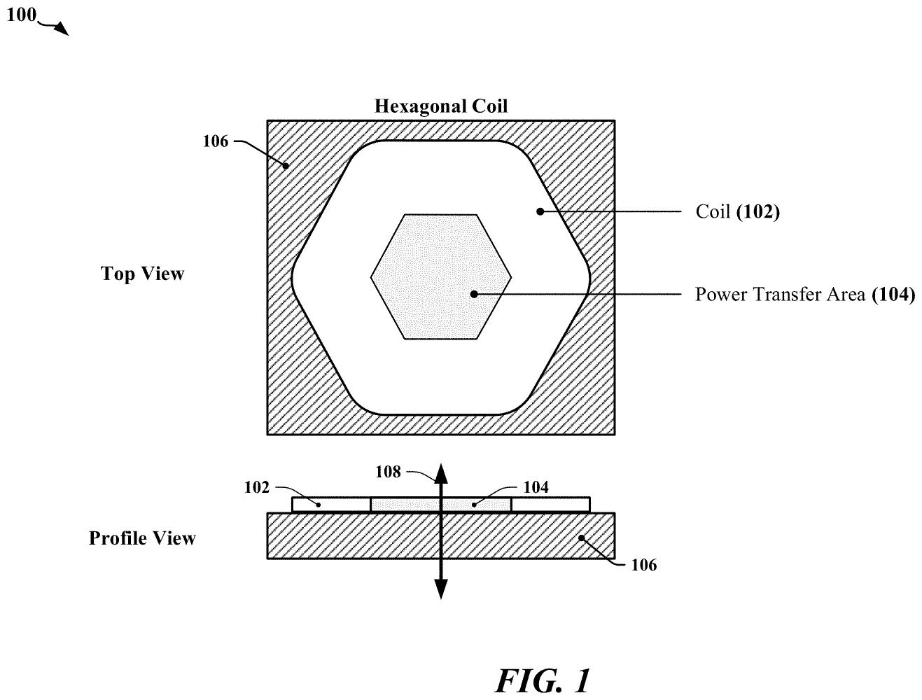

FIG. 1 illustrates an example of a charging cell 100 that may be deployed and/or configured to provide a charging surface in a wireless charging device. In this example, the charging cell 100 has a substantially hexagonal shape that encloses one or more coils 102 constructed using conductors, wires or circuit board traces that can receive a current sufficient to produce an electromagnetic field in a power transfer area 104. In various implementations, some coils 102 may have a shape that is substantially polygonal, including the hexagonal charging cell 100 illustrated in FIG. 1. Other implementations may include or use coils 102 that have other shapes. The shape of the coils 102 may be determined at least in part by the capabilities or limitations of fabrication technology or to optimize layout of the charging cells on a substrate 106 such as a printed circuit board substrate. Each coil 102 may be implemented using wires, printed circuit board traces and/or other connectors in a spiral configuration. Each charging cell 100 may span two or more layers separated by an insulator or substrate 106 such that coils 102 in different layers are centered around a common axis 108.

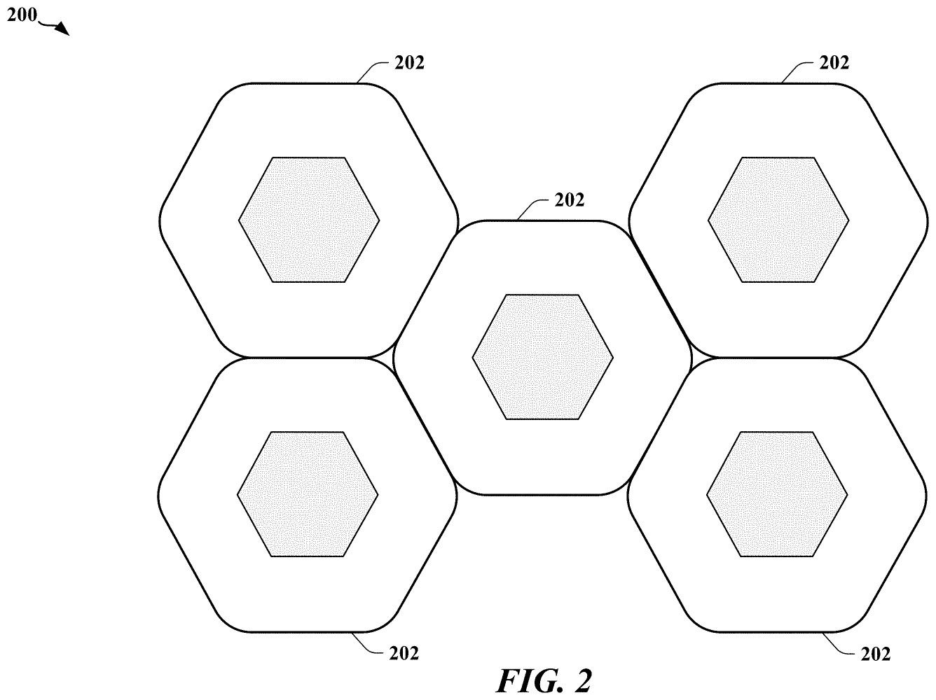

FIG. 2 illustrates an example of an arrangement 200 of charging cells 202 provided on a single layer of a segment or portion of a charging surface that may be adapted in accordance with certain aspects disclosed herein. The charging cells 202 are arranged according to a honeycomb packaging configuration. In this example, the charging cells 202 are arranged end-to-end without overlap. This arrangement can be provided without through-holes or wire interconnects. Other arrangements are possible, including arrangements in which some portion of the charging cells 202 overlap. For example, wires of two or more coils may be interleaved to some extent.

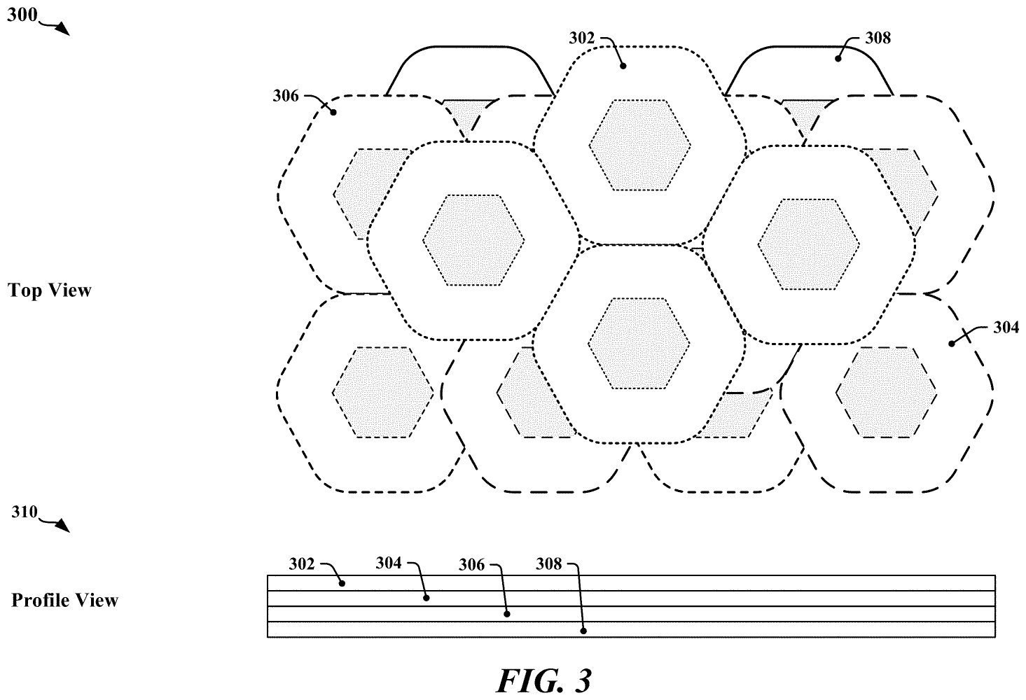

FIG. 3 illustrates an example of an arrangement of charging cells from two perspectives 300, 310 when multiple layers are overlaid within a segment or portion of a charging surface that may be adapted in accordance with certain aspects disclosed herein. Layers of charging cells 302, 304, 306, 308 are provided within the charging surface. The charging cells within each layer of charging cells 302, 304, 306, 308 are arranged according to a honeycomb packaging configuration. In one example, the layers of charging cells 302, 304, 306, 308 may be formed on a printed circuit board that has four or more layers. The arrangement of charging cells 100 can be selected to provide complete coverage of a designated charging area that is adjacent to the illustrated segment.

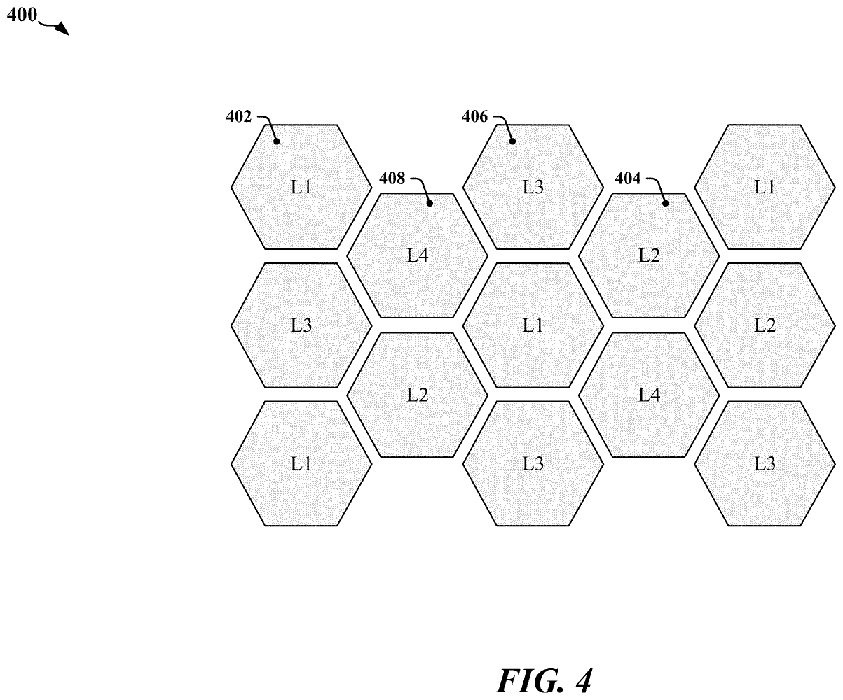

FIG. 4 illustrates the arrangement of power transfer areas provided across a charging surface 400 of a charging device that employs multiple layers of charging cells configured in accordance with certain aspects disclosed herein. The charging device may be constructed from four layers of charging cells 402, 404, 406, 408. In FIG. 4, each power transfer area provided by a charging cell in the first layer of charging cells 402 is marked “L1”, each power transfer area provided by a charging cell in the second layer of charging cells 404 is marked “L2”, each power transfer area provided by a charging cell in the third layer of charging cells 406 is marked “L3”, and each power transfer area provided by a charging cell in the fourth layer of charging cells 408 is marked “L4”.

In accordance with certain aspects disclosed herein, location sensing may rely on changes in some property of the electrical conductors that form coils in a charging cell. Measurable differences in properties of the electrical conductors may include capacitance, resistance, inductance and/or temperature. In some examples, loading of the charging surface can affect the measurable resistance of a coil located near the point of loading. In some implementations, sensors may be provided to enable location sensing through detection of changes in touch, pressure, load and/or strain. Certain aspects disclosed herein provide apparatus and methods that can sense the location of devices that may be freely placed on a charging surface using low-power differential capacitive sense techniques.

### Wireless Transmitter

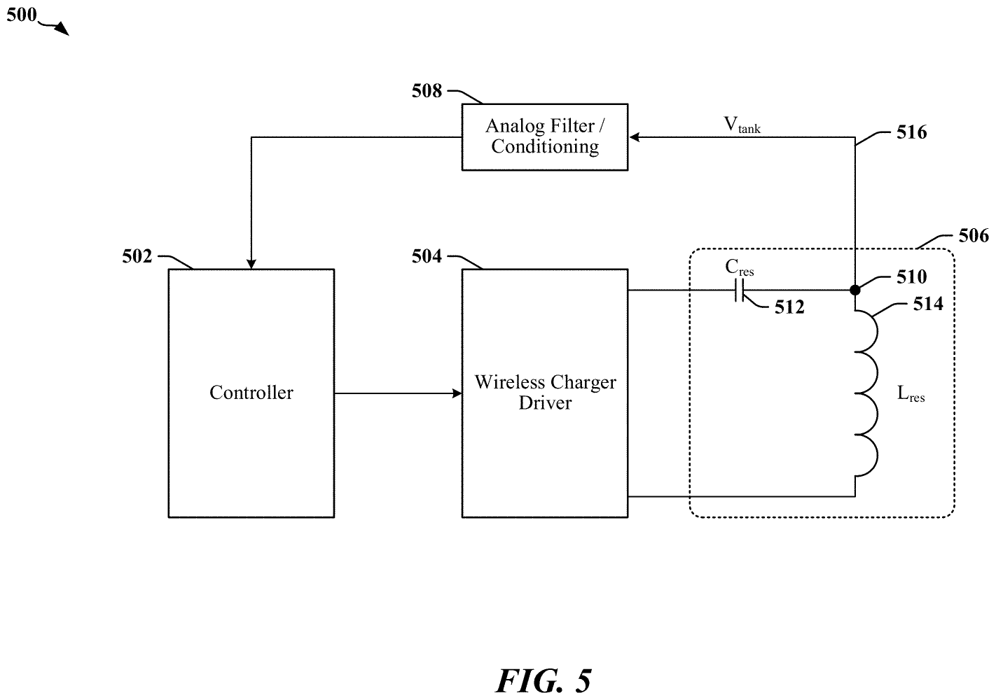

FIG. 5 illustrates an example of a wireless transmitter 500 that can be provided in a base station of a wireless charging device. A base station in a wireless charging device may include one or more processing circuits used to control operations of the wireless charging device. A controller 502 may receive a feedback signal filtered or otherwise processed by a filter circuit 508. The controller may control the operation of a driver circuit 504 that provides an alternating current to a resonant circuit 506. In some examples, the controller 502 may generate a digital frequency reference signal used to control the frequency of the alternating current output by the driver circuit 504. In some instances, the digital frequency reference signal may be generated using a programmable counter or the like. In some examples, the driver circuit 504 includes a power inverter circuit and one or more power amplifiers that cooperate to generate the alternating current from a direct current source or input. In some examples, the digital frequency reference signal may be generated by the driver circuit 504 or by another circuit. The resonant circuit 506 includes a capacitor 512 and inductor 514. The inductor 514 may represent or include one or more transmitting coils in a charging cell that produced a magnetic flux responsive to the alternating current. The resonant circuit 506 may also be referred to herein as a tank circuit, LC tank circuit, or LC tank, and the voltage 516 measured at an LC node 510 of the resonant circuit 506 may be referred to as the tank voltage.

Passive ping techniques may use the voltage and/or current measured or observed at the LC node 510 to identify the presence of a receiving coil in proximity to the charging pad of a device adapted in accordance with certain aspects disclosed herein. Some conventional wireless charging devices include circuits that measure voltage at the LC node 510 of the resonant circuit 506 or the current in the resonant circuit 506. These voltages and currents may be monitored for power regulation purposes and/or to support communication between devices. According to certain aspects of this disclosure, voltage at the LC node 510 in the wireless transmitter 500 illustrated in FIG. 5 may be monitored to support passive ping techniques that can detect presence of a chargeable device or other object based on response of the resonant circuit 506 to a short burst of energy (the ping) transmitted through the resonant circuit 506.

A passive ping discovery technique may be used to provide fast, low-power discovery. A passive ping may be produced by driving a network that includes the resonant circuit 506 with a fast pulse that includes a small amount of energy. The fast pulse excites the resonant circuit 506 and causes the network to oscillate at its natural resonant frequency until the injected energy decays and is dissipated. The response of a resonant circuit 506 to a fast pulse may be determined in part by the resonant frequency of the resonant LC circuit. A response of the resonant circuit 506 to a passive ping that has initial voltage=V₀ may be represented by the voltage V_{LC} observed at the LC node 510, such that:

$${V}_{L C} = {V}_{0} {e}^{- ( \frac{ω}{2 Q} ) t} \qquad ( Eq . 1 )$$

The resonant circuit 506 may be monitored when the controller 502 or another processor is using digital pings to detect presence of objects. A digital ping is produced by driving the resonant circuit 506 for a period of time. The resonant circuit 506 is a tuned network that includes a transmitting coil of the wireless charging device. A receiving device may modulate the voltage or current observed in the resonant circuit 506 by modifying the impedance presented by its power receiving circuit in accordance with signaling state of a modulating signal. The controller 502 or other processor then waits for a data modulated response that indicates that a receiving device is nearby.

### Selectively Activating Coils

According to certain aspects disclosed herein, power transmitting coils in one or more charging cells may be selectively activated to provide an optimal electromagnetic field for charging a compatible device. In some instances, power transmitting coils may be assigned to charging cells, and some charging cells may overlap other charging cells. The optimal charging configuration may be selected at the charging cell level. In some examples, a charging configuration may include charging cells in a charging surface that are determined to be aligned with or located close to the device to be charged. A controller may activate a single power transmitting coil or a combination of power transmitting coils based on the charging configuration which in turn is based on detection of location of the device to be charged. In some implementations, a wireless charging device may have a driver circuit that can selectively activate one or more power transmitting coils or one or more predefined charging cells during a charging event.

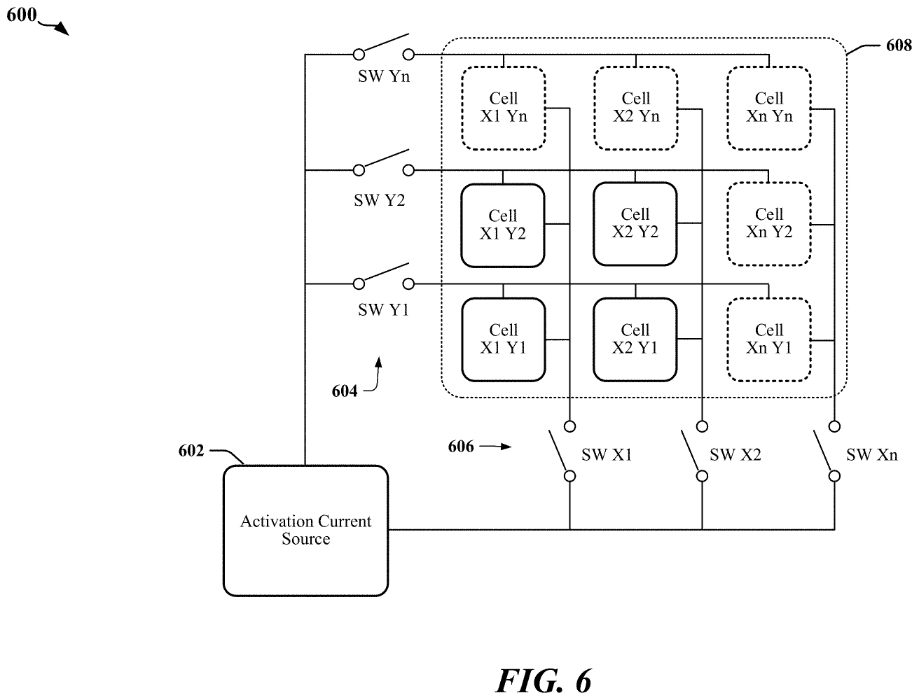

FIG. 6 illustrates a first topology 600 that supports matrix multiplexed switching for use in a wireless charging device adapted in accordance with certain aspects disclosed herein. The wireless charging device may select one or more charging cells 100 to charge a receiving device. Charging cells 100 that are not in use can be disconnected from current flow. A relatively large number of charging cells 100 may be used in the honeycomb packaging configuration illustrated in FIGS. 2 and 3, requiring a corresponding number of switches. According to certain aspects disclosed herein, the charging cells 100 may be logically arranged in a matrix 608 having multiple cells connected to two or more switches that enable specific cells to be powered. In the illustrated topology 600, a two-dimensional matrix 608 is provided, where the dimensions may be represented by X and Y coordinates. Each of a first set of switches 606 is configured to selectively couple a first terminal of each cell in a column of cells to a first terminal of a voltage or current source 602 that provides current to activate coils in one or more charging cells during wireless charging. Each of a second set of switches 604 is configured to selectively couple a second terminal of each cell in a row of cells to a second terminal of the voltage or current source 602. A charging cell is active when both terminals of the cell are coupled to the voltage or current source 602.

The use of a matrix 608 can significantly reduce the number of switching components needed to operate a network of tuned LC circuits. For example, N individually connected cells require at least N switches, whereas a two-dimensional matrix 608 having N cells can be operated with √N switches. The use of a matrix 608 can produce significant cost savings and reduce circuit and/or layout complexity. In one example, a 9-cell implementation can be implemented in a 3×3 matrix 608 using 6 switches, saving 3 switches. In another example, a 16-cell implementation can be implemented in a 4×4 matrix 608 using 8 switches, saving 8 switches.

During operation, at least 2 switches are closed to actively couple one coil or charging cell to the voltage or current source 602. Multiple switches can be closed at once in order to facilitate connection of multiple coils or charging cells to the voltage or current source 602. Multiple switches may be closed, for example, to enable modes of operation that drive multiple transmitting coils when transferring power to a receiving device.

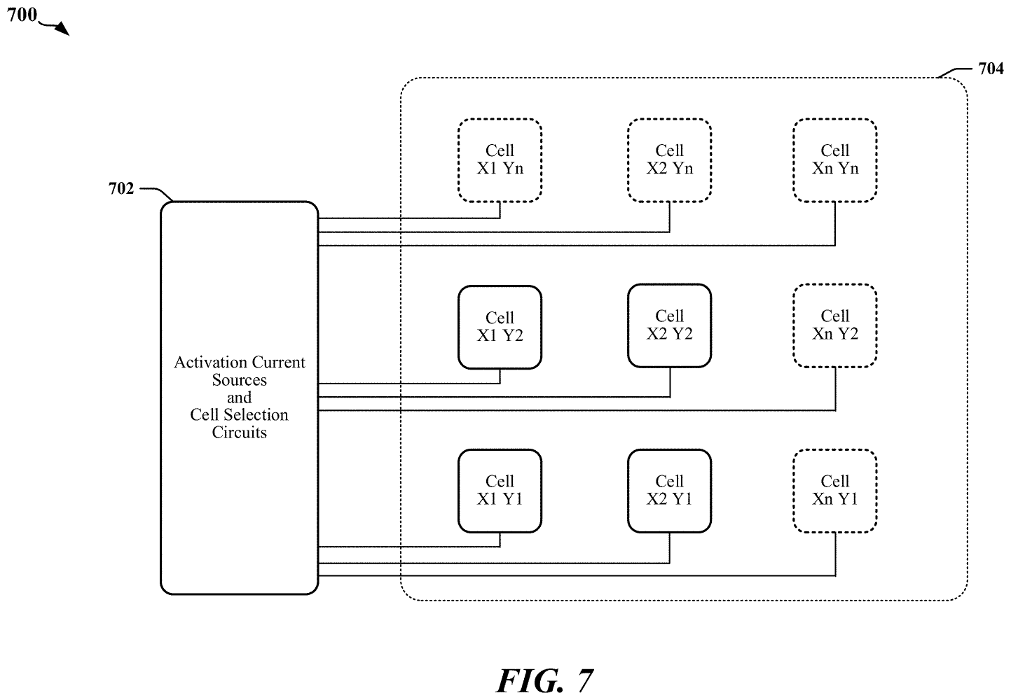

FIG. 7 illustrates a second topology 700 in which each individual coil or charging cell is directly driven by a driver circuit 702 in accordance with certain aspects disclosed herein. The driver circuit 702 may be configured to select one or more coils or charging cells 100 from a group of coils 704 to charge a receiving device. It will be appreciated that the concepts disclosed here in relation to charging cells 100 may be applied to selective activation of individual coils or stacks of coils. Charging cells 100 that are not in use receive no current flow. A relatively large number of charging cells 100 may be in use and a switching matrix may be employed to drive individual coils or groups of coils. In one example, a first switching matrix may configure connections that define a charging cell or group of coils to be used during a charging event and a second switching matrix may be used to activate the charging cell and/or group of selected coils.

### Multi-Coil Wireless Chargers Provided in Containers

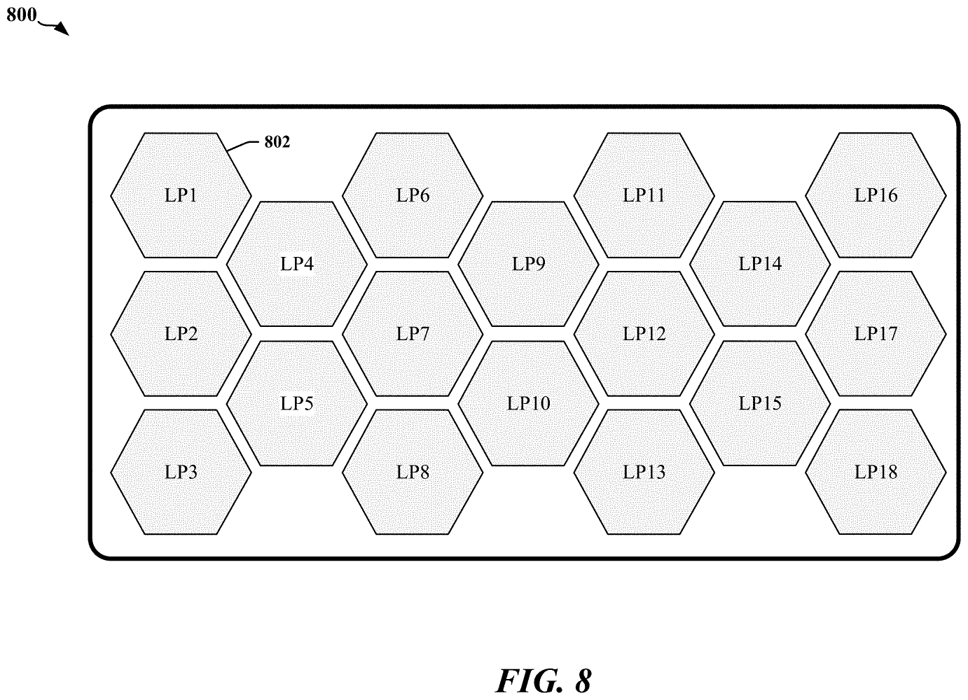

FIG. 8 illustrates an example of a charging surface 800 provided by a wireless charging system. The charging surface 800 may be used to charge one or more devices, such as a mobile telephone, a smart phone, a tablet computer, smart watch, smart eyewear, headsets, earbuds, or another type of mobile device and/or wearable device. A device to be charged can engage and electromagnetically couple with one or more transmitting coils (marked LP-1 through LP-18) in the charging surface 800. The charging surface 800 is depicted as a planar, occupying a two-dimensional area, although the charging surface 800 can take other shapes and forms. For example, another charging surface may be curved or include angled portions. In some examples, the charging surface 800 may be constructed as a flexible circuit and may adopt a flat or curved shape as desired.

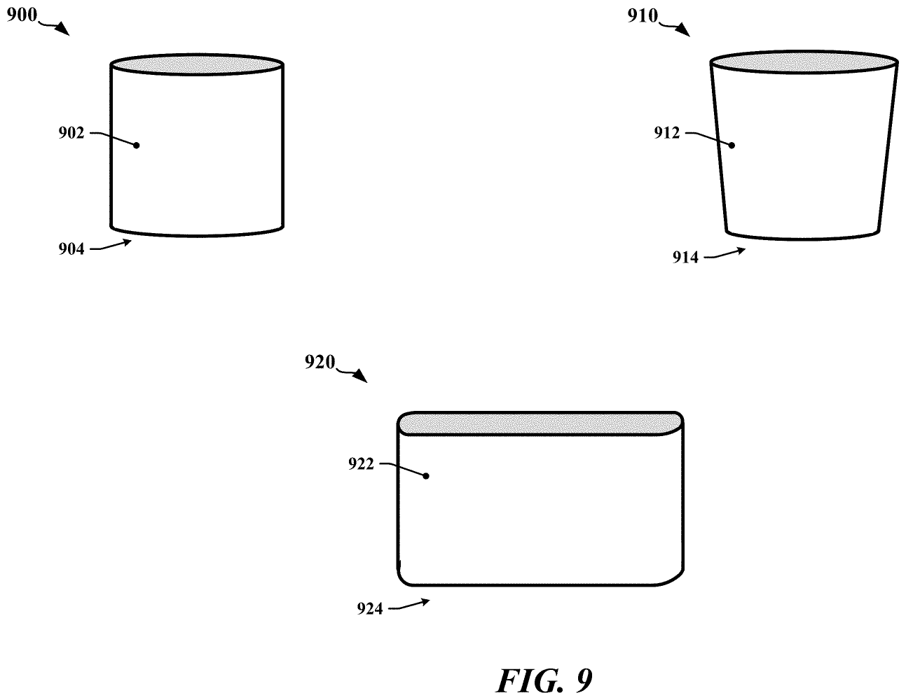

In some implementations, the charging surface 800 may be provided within a structure that is configured to receive, position and charge one or more devices placed within the structure. In one example, the structure can also function as a cupholder, or may be an insert configured to fit within a cupholder. In various examples, the structure may take the shape of a cylinder, a cone, a frustum or other shape. FIG. 9 illustrates examples of structures 900, 910, 920 that may include or be fitted with a charging surface 800. A cylindrical structure 900 or frustoconical structure 910 may include or be configured to receive and maintain one or more charging surfaces 800. In these examples, the charging surfaces 800 may be coupled to a control and driver circuit that can manage and control the operation of multiple charging surfaces 800.

In some examples, a flexible charging surface 800 may be embedded in the wall 902, 912 of the cylindrical structure 900 or frustoconical structure 910. In another example, the flexible charging surface 800 may be embedded in the base 904, 914 of the cylindrical structure 900 or frustoconical structure 910. In another example, the flexible charging surface 800 may be attached to or placed adjacent to the inner or outer surface of the wall 902, 912 of the cylindrical structure 900 or frustoconical structure 910. In another example, the flexible charging surface 800 may be attached or placed adjacent to the top or bottom surface of the base 904, 914 of the cylindrical structure 900 or frustoconical structure 910.

An elongated structure 920 may include or be fitted with one or more units of the charging surface 800. In one example, the flexible charging surface 800 may be embedded in the wall 922 of the elongated structure 920. In another example, the flexible charging surface 800 may be embedded in the base 924 of the elongated structure 920. In another example, the flexible charging surface 800 may be attached or placed adjacent to the inner or outer surface of the wall 922 of the elongated structure 920. In another example, the flexible charging surface 800 may be attached or placed adjacent to the top or bottom surface of the base 904, 914 of the elongated structure 920. In some instances, the elongated structure 920 may be a pocket on the door of a vehicle, in a briefcase, or other item of luggage and or may be part of a storage system, configured to hold documents, writing implements, tools, keys or other objects.

The illustrated structures 900, 910, 920 represent a subset of the structures that may be adapted in accordance with certain aspects of this disclosure. The example of a cupholder will be used to facilitate descriptions of one or more aspects. The described cupholder may be implemented using the cylindrical structure 900 or the frustoconical structure 910. In some instances, the cupholder may be an insert, or may serve as an insulating sleeve or size adapter for a cup placed in the cupholder.

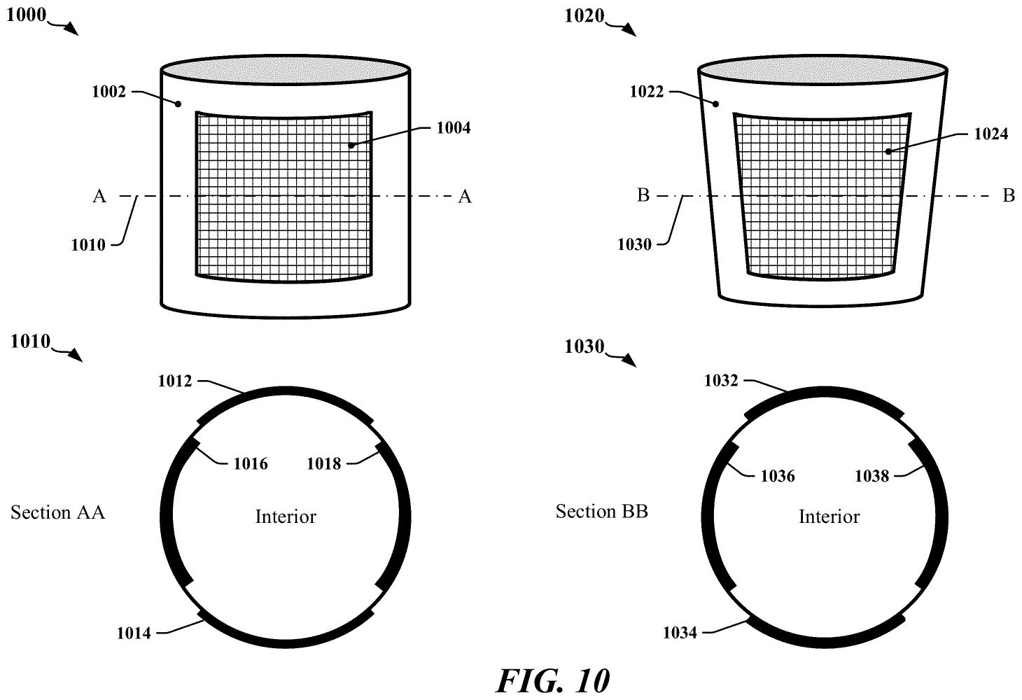

FIG. 10 illustrates examples of cupholders 1000, 1020 that include one or more charging elements 1004, 1024 that combine to provide a charging surface within the cupholders 1000, 1020. The first cupholder 1000 is generally cylindrical in shape and the second cupholder 1020 has a frustoconical shape. In the example, the charging elements 1004, 1024 are embedded in or attached to a wall 1002, 1022 of the respective cupholders 1000, 1020. In one example, the first cupholder 1000 may form part of a fixture in an automobile, airplane or other vehicle and/or in furniture such as a chair or recliner. In another example, the first cupholder 1000 may be an insert that can be fitted to a cupholder fixture. The second cupholder 1020 may be usable in the same manner as the first cupholder 1000. In addition, the first cupholder 1000 and/or the second cupholder 1020 may be open-ended and may serve as a sleeve or collar used to provide insulation and/or enhance fit of a cup or other container in a larger cupholder.

As illustrated in the section views 1010 and 1030 of the first cupholder 1000 and the second cupholder 1020, various options for placing charging elements 1004, 1024 are available. In the illustrated example, certain external placement options 1012, 1014, 1032, 1034 and internal placement options 1016, 1018, 1036, 1038 are shown. These options are by no means exhaustive and many variations are contemplated. In one example, a single flexible charging surface may be attached or coupled to the inner surface or outer surface of the first cupholder 1000 and/or the second cupholder 1020. In another example, a multiple charging surfaces may be deployed across the inner surface or outer surface of the first cupholder 1000 and/or the second cupholder 1020. In another example, one or more charging surfaces may be embodied in the wall of the first cupholder 1000 and/or the second cupholder 1020. The circuit boards or flexible circuits may be configured to receive power from an external power supply or, in the case of a vehicle from the vehicle power distribution system.

Charging surfaces deployed using the external placement options 1012, 1014, 1032, 1034 and/or the internal placement options 1016, 1018, 1036, 1038 may be implemented using flexible circuits, where all components of the charging surfaces can be elastically stretched or compressed. The components of the charging surface may include a flexible PCB, one or more flexible transmitting coils and/or a flexible ferrite layer. Control circuits, connectors and other components may be arranged on the flexible PCB. In some implementations, at least some control circuits are located externally from the flexible PCB. In one example, the control circuits include connectors that receive power from an external power supply or, in the case of a vehicle from the vehicle power distribution system.

In some examples, a separate driver PCB may be connected to one or more flexible PCBs that implement the charging surface. Each flexible PCB that implements a charging surface may include multiple transmitting coils arranged in a pattern configured to provide multiple points on the charging surface at which electromagnetic flux can be generated, thereby enabling a wide range of receiving coil placement in chargeable devices to be supported.

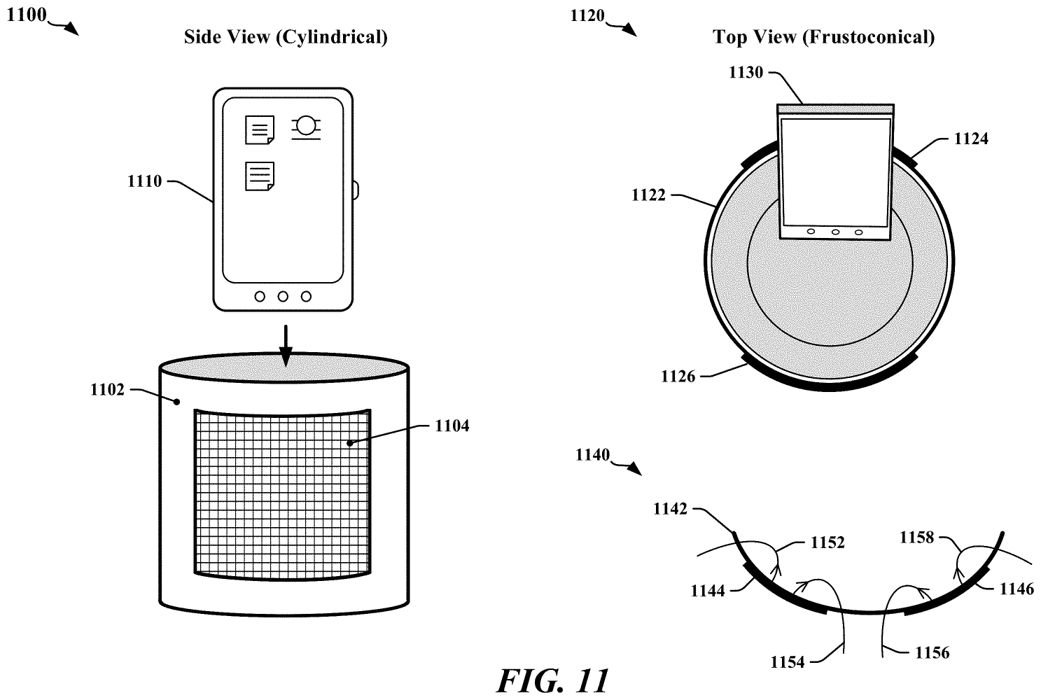

FIG. 11 illustrates certain aspects of a charging system that may be provided in a structure such as a cupholder, insert and/or sleeve. In a first configuration 1100, a cylindrical cupholder 1102 has one or more charging elements 1104 attached to or embedded in the side wall. The two charging elements 1104 provided on opposite sides of the cylindrical cupholder 1102 may be capable of providing 360° coverage of the interior of the cylindrical cupholder 1102 without physically covering the wall of the cylindrical cupholder 1102. In this example, a charging configuration can be selected that provides sufficient electromagnetic flux to charge a device 1110 placed anywhere in the cylindrical cupholder 1102. Power may be provided through the wall or bottom of the cylindrical cupholder 1102. In one example, power is received from an external power supply. In another example, power is received cylindrical cupholder 1102 is coupled directly to a vehicle power distribution system and the cylindrical cupholder 1102 may be wired to connect the charging elements 1104 to the vehicle power distribution system.

In a second configuration 1120, a frustoconical cupholder 1122 has a charging surface provided by two charging elements 1124, 1126 attached to the outside of the side wall. In one example, the two charging elements 1124, 1126 provided on opposite sides of the frustoconical cupholder 1122 can provide 360° coverage of the interior of the frustoconical cupholder 1122, such that a charging configuration can be selected that provides sufficient electromagnetic flux to charge a device 1130 placed at any location or orientation within the frustoconical cupholder 1122. Power may be provided through the wall or bottom of the frustoconical cupholder 1122. In one example, power is received from an external power supply. In another example, power is received frustoconical cupholder 1122 is coupled directly to a vehicle power distribution system and the frustoconical cupholder 1122 may be wired to connect the charging elements 1144 to the vehicle power distribution system.

The charging configuration 1140 illustrated in FIG. 11 employs multiple charging elements 1144, 1146 provided on a wall 1142 of a structure. Electromagnetic flux 1152, 1154, 1156, 1158 is produced by the charging elements 1144, 1146. In the illustrated example, constructive interference between electromagnetic flux 1154, 1156 produced by two or more charging elements 1144, 1146 may be used to maximize coverage between transmitting coils of the charging elements 1144, 1146.

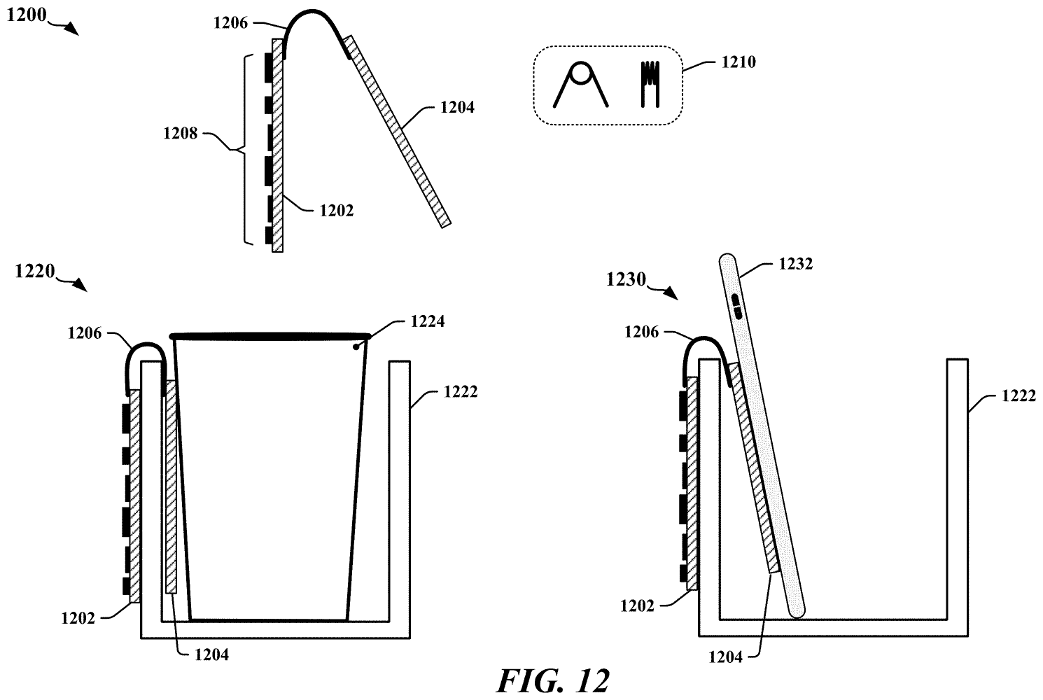

FIG. 12 illustrates a charging apparatus 1200 that may be inserted in a container 1222. The illustrated charging apparatus 1200 includes two PCBs 1202 and 1204 coupled by an interconnect 1206. A first PCB 1202 may carry control, power management and device detection circuits in one or more integrated 1208 deployed on at least one side of the first PCB 1202. The first PCB 1202 may receive power from an external power supply or from a vehicle power distribution system.

A second PCB 1204 may have a number of transmitting coils provided across one or more sides of the second PCB 1204 and may include a ferrite or other type of shielding layer. The second PCB 1204 may receive charging current from the first PCB 1202 to energize one or more transmitting coils. A charging configuration may be determined by one or more circuits on the first PCB 1202 based on detection of presence and/or location of a chargeable device placed adjacent to the second PCB 1204. In some examples, circuits on the first PCB 1202 cooperate with switching circuits on the second PCB 1204 to conduct the charging current to transmitting coils selected for inclusion in the charging configuration.

The first PCB 1202 and the second PCB 1204 may be coupled through the interconnect 1206. The interconnect may include electrical and a mechanical connector. The electrical connectors may include wires, flexible circuits or other suitable electrically conductive devices. The mechanical connector may provide resilient, connective members and devices that provide the interconnect 1206 with sufficient tensile strength to withstand stresses caused by manipulation of the interconnect 1206 and/or charging apparatus.

In one example, the mechanical connector includes a resilient band that can be deformed from an original shape, allowing the interconnect 1206 to be bent and/or rotated about an axis. The resilient band may be configured to absorb and retain deformation energy while the interconnect 1206 is held in a position that causes the interconnect 1206 to be bent or rotated. The resilient band may release the deformation energy when the interconnect is released, causing the original shape of the interconnect 1206 to be restored.

In another example, the mechanical connector includes a torsion spring 1210 that allows the charging apparatus 1200 to be bent and/or rotated about an axis defined by the torsion spring 1210. The torsion spring 1210 absorbs and retains deformation energy while the charging apparatus 1200 is held in a position that causes the interconnect 1206 to be bent or rotated. The torsion spring 1210 releases the deformation energy when the interconnect is released, causing the original shape of the charging apparatus 1200 to be restored.

The container 1222 may be cylindrical or have an elongated shape. In the illustrated example, the container 1222 is cylindrical and may function as a cupholder. The charging apparatus 1200 may be folded over a side of the container 1222. In a first configuration 1220, a cup 1224 is placed within the container 1222. The container may occupy substantially all of the interior of the container 1222, such that the second PCB 1204 is pushed to a vertical or near-vertical orientation and against a side wall of the container 1222. The interconnect 1206 is deformed in response to the force applied by the cup 1224 on the second PCB 1204.

In a second configuration 1230, a smartphone 1232 is placed within the container 1222 such that it rests against the second PCB 1204. The resilient mechanical connector permits the interconnect 1206 to be deformed in response to the force applied by the smartphone 1232, while maintaining an orientation of the second PCB 1204 that is substantially parallel to the orientation of the smartphone 1232. The second configuration 1230 may cause the charging apparatus 1200 to present a charging surface to the smartphone 1232 that permits an optimized coupling of electromagnetic flux between the second PCB 1204 and the smartphone 1232.

Certain aspects of this disclosure apply to a wireless charging system that is configured to provide a distributed charging surface. From the perspective of control logic, the distributed charging surface may appear to be a single charging surface. The distributed charging surface may be implemented using two or more charging modules, located physically apart to provide physically distributed charging surface portions that can be operated as a single logical charging surface. Each of the which may also be capable of functioning as a standalone charging device.

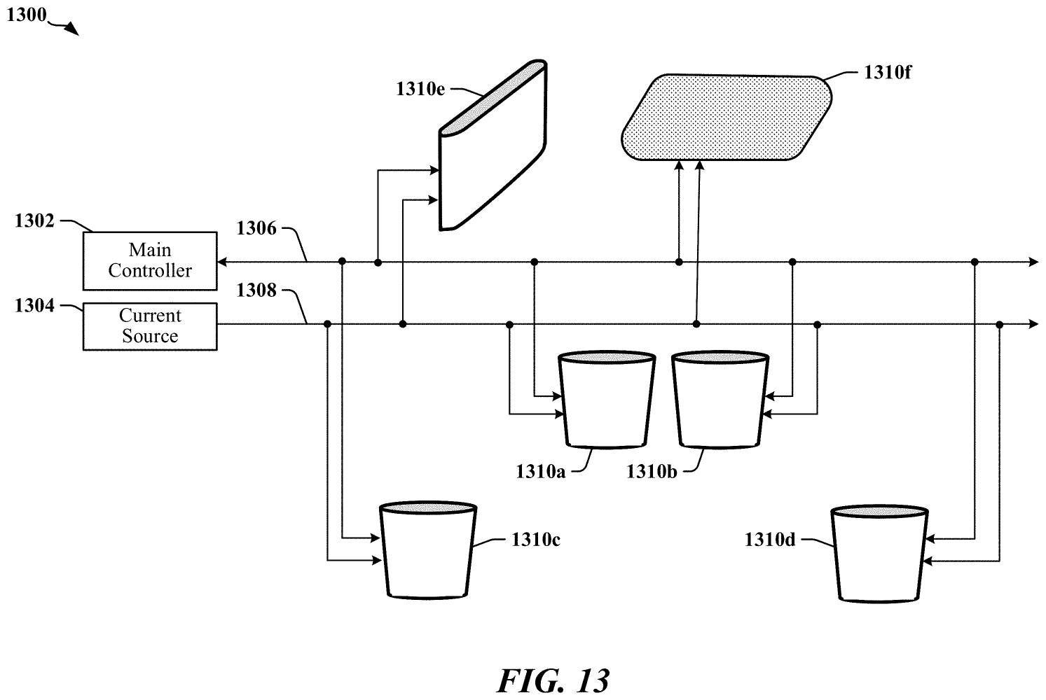

FIG. 13 illustrates an example of a wireless charging system 1300 that provides or operates a distributed charging surface. The distributed charging surface includes charging surfaces provided by multiple charging devices 1310a-1310f. One or more of the charging devices 1310a-1310f includes a local controller configured to direct charging current to charging cells in the charging devices 1310a-1310f. One or more of the charging devices 1310a-1310f includes a local controller that can be configured to manage or control charging procedures involving one or more chargeable devices placed near a charging surface of the charging device 1310a-1310f. One or more of the charging devices 1310a-1310f includes a local controller that can be configured to detect presence of a chargeable device placed near a charging surface of the charging device 1310a-1310f. One or more of the charging devices 1310a-1310f includes a local controller that can be configured to define a charging configuration for charging a chargeable device placed near a charging surface of the charging device 1310a-1310f.

The illustrated wireless charging system 1300 may be deployed within an automobile or other type of vehicle and the charging devices 1310a-1310f may be embedded in surfaces such as a console, armrest or dashboard, or may be configured to hold and charge portable devices in addition to other functions. The illustrated wireless charging system 1300 includes charging devices 1310a-1310d that also serve as cupholders, one or more charging devices 1310e that is provided in a glove box or mapholder, and one or more charging devices 1310f that is embedded in a surface upon which a chargeable device may be laid.

In one example, a main controller 1302 is provided to manage and control charging and/or device discovery procedures for the wireless charging system 1300. The main controller 1302 may delegate certain functions to local controllers provided in one or more of the charging devices 1310a-1310f. In some examples, the main controller 1302 may be provided in provided in one of the charging devices 1310a-1310f. In some examples, the main controller 1302 may be provided as separate entity, or may be implemented in or cooperate with in-vehicle processing systems. In the latter examples, the physical separation of main controller 1302 from the charging devices 1310a-1310f may enable the charging devices 1310a-1310f to operate with thin charging surfaces that can be attached to or embed in an object of furniture or a surface in a vehicle. The main controller 1302 may communicate with one or more of the charging devices 1310a-1310f or the in-vehicle processing systems through a serial bus 1306. In some examples, the serial bus 1306 may be operated in accordance with an Improved Inter-Integrated Circuit (I3C) protocol, Controller Area Network (CAN) protocol, Local Interconnected Network (LIN) protocol, or the like.

A current source 1304 may be provided that generates a charging current 1308 to be used by the charging devices 1310a-1310f. The current source 1304 may receive power from a vehicular power supply. In some examples, one or more of the charging devices 1310a-1310f includes local current sources.

In some examples, the charging devices 1310a-1310f may include local control circuits that can be used to monitor, configure and manage charging operations through their respective charging surfaces. In some instances, the control circuits may include processing devices or switches that enable the local control circuit in a first modular charging device to manage and control charging and/or device discovery in a second modular charging device, including where the second modular charging device is spaced apart or otherwise physically separated from the first modular charging device. The control circuits may control flow of charging current 1308 by controlling access to a power source, such as the current source 1304, or by directing the charging current 1308 to independent groupings of coils provided on multiple PCBs in interconnected charging devices. The control circuits may be configured to define physically independent charging zones that can be managed and operated as a single system. In one example, the independent charging zones may be deployed in multiple locations within a confined space, such as within a cabin of a car or other vehicle or form of transportation.

A modular or physically-distributed charging surface may be configured to optimize concurrent wireless charging of devices that have a variety of sizes and shapes or that have different sized receiving coils. Concurrent wireless charging of devices may be optimized when a maximum number of devices can be charged simultaneously without compromising speed of charging devices associated with high power consumption. In one example, a wireless charging system may be expected to charge a tablet computer and multiple smaller devices such as a smartwatch or mobile telephone. Optimal charging of the tablet computer may necessitate the use of a large transmitting coil, while smaller transmitting coils may facilitate stacking of physically smaller devices or devices associated with low power consumption by providing a larger number of charging cells within an area of the charging surface.

In one aspect of the disclosure, a mixture of modular or physically-distributed charging surfaces can be connected or coupled to provide different charging zones with different charging cell sizes. In another aspect of the disclosure, certain modular or physically-distributed charging surfaces can include different charging zones with different charging cell sizes. In another aspect of the disclosure, a standalone charging surface can include different charging zones with different charging cell sizes.

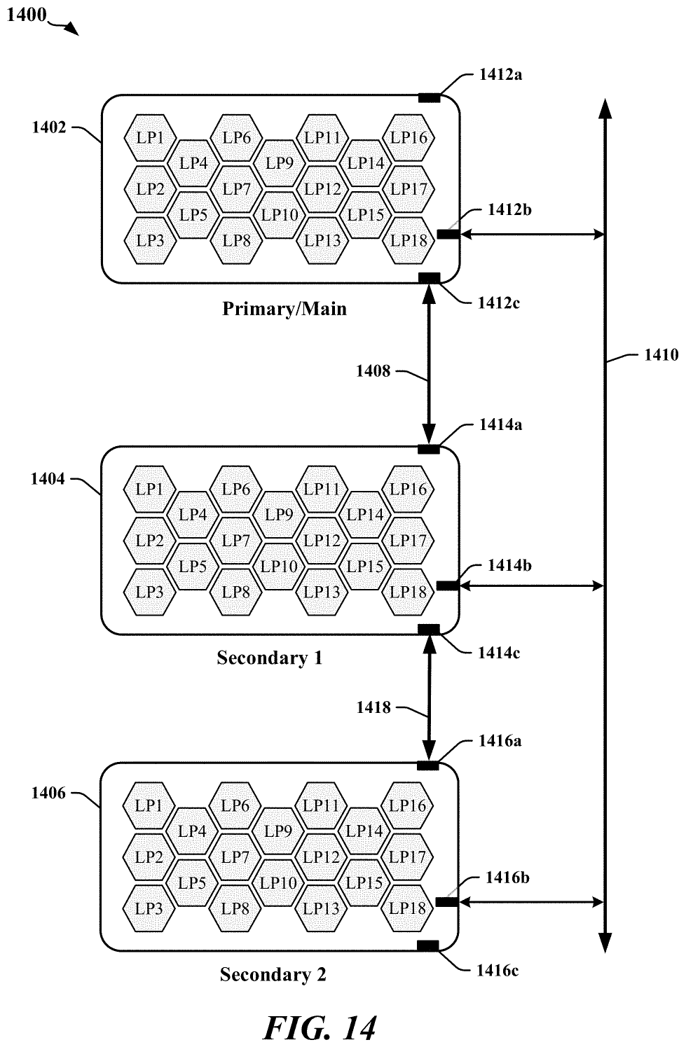

FIG. 14 illustrates an example of a charging system 1400 that includes multiple charging devices 1402, 1404, 1406 provided in accordance with certain aspects of this disclosure. In one example, the charging devices 1402, 1404, 1406 may be physically joined or interconnected to provide a single scalable, modular charging surface. In some examples, one or more of the charging devices 1402, 1404, 1406 may be remotely located from at least one other charging device 1402, 1404, 1406 to provide a distributed charging surface. The charging system 1400 may include one or more controllers that can communicate with the charging devices 1402, 1404, 1406. In one example, a primary controller may communicate control messages to a secondary controller over a data communication link. In some examples, a primary controller may provide control signals that are used to control charging or detection operations at the charging devices 1402, 1404, 1406. In some examples, the primary controller may control power flow in the charging devices 1402, 1404, 1406. In some examples, the primary controller may provide charging currents to one or more groups of charging coils on the charging devices 1402, 1404, 1406.

Each charging device 1402, 1404, 1406 may include one or more charging cells that encompass one or more power transfer areas. Each power transfer area is substantially planar and centered around an axis that is substantially perpendicular to its a charging surface of its associated charging device 1402, 1404, 1406. In some examples, each of the charging devices 1402, 1404, 1406 can operate as a standalone wireless charger that includes controllers and power management circuits. The standalone wireless charger may be configured to detect chargeable devices, generate charging configurations and provide a charging current to one or more charging cells identified by the charging configurations.

In some examples, certain charging devices 1404, 1406 operate as secondary devices that have limited capability. In one example, the limited-capability charging devices 1404, 1406 receive charging currents through dedicated connectors and the charging currents are directed to one or more charging cells through fixed electrical paths or through a switch that may be controlled by a primary charging device 1404 or other centralized or distributed controller. In another example, the limited-capability charging devices 1404, 1406 may have a controller capable of selecting charging cells to receive a charging current and to provide the charging current to the selected charging cells. In the latter example, some limited-capability charging devices 1404, 1406 may be configured to exchange messages with one or more other charging devices 1402, 1404, 1406 in the system, or exchange messages with a chargeable device. In some instances, the limited-capability charging devices 1404, 1406 may be capable of conducting searches for chargeable devices or may be configured to participate in a search for chargeable devices controlled by a primary charging device 1404 or other centralized or distributed controller.

The charging system 1400 is constructed from interconnected charging devices 1402, 1404, 1406. The charging devices 1402, 1404, 1406 may have a same or different size or shape. The charging devices 1402, 1404, 1406 may have a same or different number or configuration of power transmitting coils. In the illustrated example, the charging devices 1402, 1404, 1406 are illustrated as having similar size, shape and transmitting coil configuration, although the charging system 1400 may be used with charging devices that have different sizes, different shapes or different transmitting coils. For example, the charging devices 1402, 1404, 1406 may correspond to the charging devices 1310a-1310f illustrated in FIG. 13 in some implementations.

In certain examples, each of the charging devices 1402, 1404, 1406 includes one or more connectors 1412a, 1412b, 1412c, 1414a 1414b, 1414c, 1416a 1416b, 1416c, which may couple the charging devices 1402, 1404, 1406 to a multi-drop serial bus 1410 or support a daisy chain connection 1408, 1418. In one example, the multi-drop serial bus 1410 is configured as a serial bus that enables the charging devices 1402, 1404, 1406 to exchange command and control messages. In one example, the serial bus is operated in accordance with an I3C protocol, a CAN protocol, a LIN protocol, or the like. In some instances, the charging devices 1402, 1404, 1406 may communicate wirelessly. In some implementations, the daisy chain connection 1408, 1418 is used to distribute charging current among the charging devices 1402, 1404, 1406. The daisy chain connection 1408, 1418 may also be used for exchanging command and control messages.

In one example, one or more of the charging devices 1402, 1404, 1406 can serve as a primary device and may include a processing circuit configured to manage operation of one or more charging devices 1402, 1404, 1406 that is operated as a secondary device. In the illustrated example, two charging devices 1404, 1406 operate as secondary devices and may include processing circuits configured to communicate over the multi-drop serial bus 1410 in order to receive commands from the primary charging device 1402 and to report feedback information to the primary charging device 1402. Secondary charging devices 1402, 1404, 1406 may include or control a driver circuit that provides a flow of a charging current provided through the daisy chain connection 1408, 1418, when the charging current is provided by a current source through the operation of the primary charging device 1402.

The secondary charging devices 1404, 1406 may cooperate with the primary charging device 1402 to discover, enumerate and configure the combination of charging devices 1402, 1404, 1406 provided in the charging system 1400. In one example, the secondary charging devices 1404, 1406 participate in a serial bus arbitration process to identify themselves to the primary charging device 1402 and/or to obtain unique addresses. In another example, the secondary charging devices 1404, 1406 may be preconfigured with at least a secondary address that the primary charging device 1402 can use to address each secondary charging device 1404, 1406 through the multi-drop serial bus 1410. The primary charging device 1402 may use the multi-drop serial bus 1410 to configure the secondary charging devices 1404, 1406, interrogate the secondary charging devices 1404, 1406 for capability, charging cell size, number and configuration as well as status information. The primary charging device 1402 may use the multi-drop serial bus 1410 to configure the secondary charging devices 1404, 1406 for one or more charging operations.

In some implementations, each of the charging devices 1402, 1404, 1406 can be independently connected to a power supply that can be used to provide and configure a charging current. In one example, the charging devices 1402, 1404, 1406 may include an inverter or switching power supply configurable to produce an alternating current (AC) that has frequency suitable for wireless charging. In some implementations, each of the charging devices 1402, 1404, 1406 may be coupled to a multi-purpose communication bus that is used by other devices or systems (in an automobile for example). In the latter implementations, the primary charging device 1402 may also be a controlling entity on the bus.

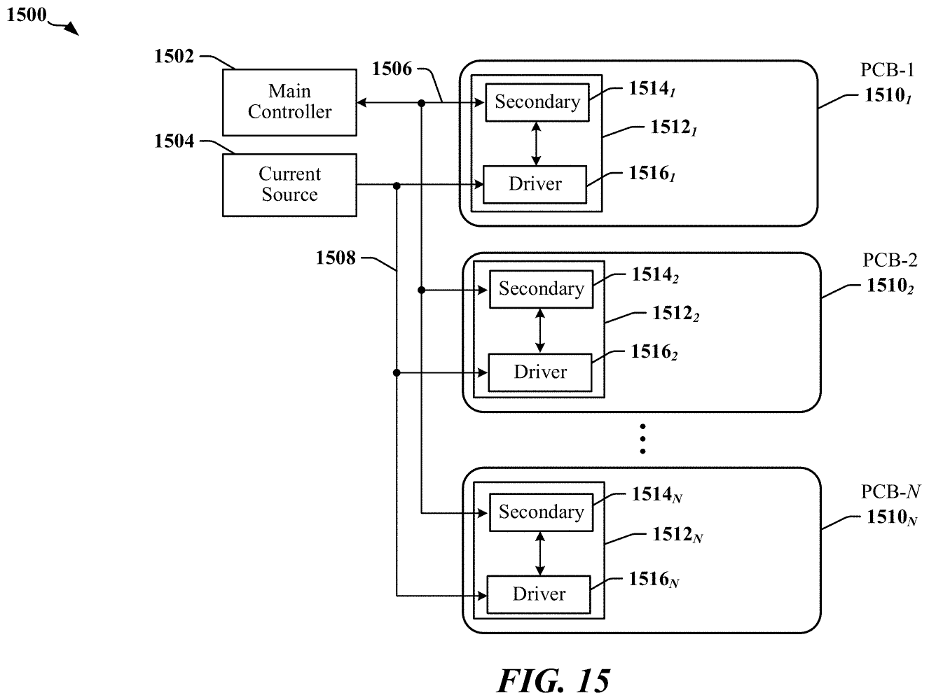

FIG. 15 illustrates a first example of a combined control circuit 1500 in a charging system provided in accordance with certain aspects disclosed herein. Each PCB 1510₁-1512_{N} includes a processing circuit 1512₁-1512_{N} that is configured and controlled by a main controller 1502 to manage operation of its respective PCB 1510₁-1512_{N}. In one example, each processing circuit 1512₁-1512_{N} includes a secondary circuit 1514₁-1514_{N} configured to communicate over a serial bus 1506 in order to receive commands and report feedback information to the main controller 1502. The secondary circuit 1514₁-1514_{N} may control a driver circuit 1516₁-1516_{N} that controls flow of a charging current provided through an interlink 1508 by a current source.

The secondary circuits 1514₁-1514_{N} may cooperate with the main controller 1502 to discover, enumerate and configure the combination of PCBs 1510₁-1512_{N} provided in the modular charging surface. In one example, the secondary circuits 1514₁-1514_{N} participate in an arbitration process to identify themselves to the main controller 1502 and/or to obtain unique addresses. In another example, the secondary circuits 1514₁-1514_{N} may be preconfigured with at least a secondary address that the main controller 1502 can use to address each secondary circuit 1514₁-1514_{N} through the serial bus 1506. The main controller 1502 may use the serial bus 1506 to configure the secondary circuits 1514₁-1514_{N}, interrogate the secondary circuits 1514₁-1514_{N} for capability and status information, and configure the secondary circuits 1514₁-1514_{N} for one or more charging operations.

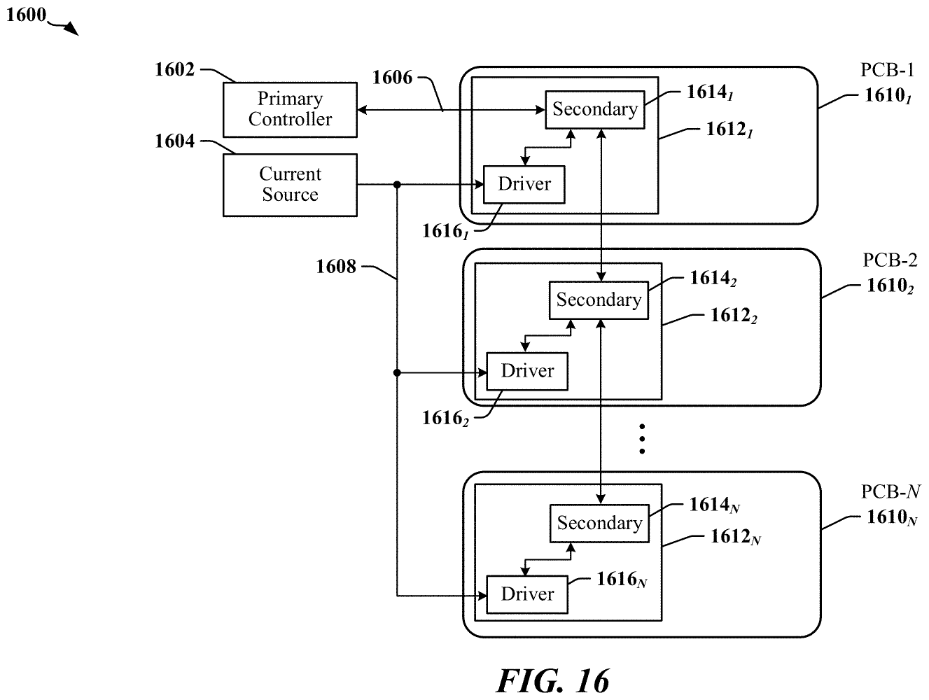

FIG. 16 illustrates a second example of a combined control circuit 1600 that may be provided in a charging system provided in accordance with certain aspects disclosed herein. Each PCB 1610₁-1612_{N} includes a processing circuit 1612₁-1612_{N} that is configured and controlled by a main controller 1602 to manage operation of its respective PCB 1610₁-1612_{N}. In one example, each processing circuit 1612₁-1612_{N} includes a secondary circuit 1614₁-1614_{N} configured to communicate over a serial bus 1606 in order to receive commands and report feedback information to the main controller 1602. The secondary circuit 1614₁-1614_{N} may control a driver circuit 1616₁-1616_{N} that controls flow of a charging current provided through an interlink 1608 by a current source.

The secondary circuits 1614₁-1614_{N} may cooperate with the main controller 1602 to discover, enumerate and configure the combination of PCBs 1610₁-1612_{N} provided in the modular charging surface. In the illustrated example, the secondary circuits 1614₁-1614_{N} are connected in a daisy chain fashion, whereby the main controller 1602 connects with and configures a first secondary circuit 1614₁, which then couples the second secondary circuit 1614₂ to the main controller 1602 through the serial bus 1606. The main controller 1602 configures the second secondary circuit 1614₂ and the process continues until the last secondary circuit 1614_{N} has been configured. In another example, the secondary circuits 1614₁-1614_{N} may be preconfigured with at least a secondary address that the main controller 1602 can use to address each secondary circuit 1614₁-1614_{N} through the serial bus 1606.

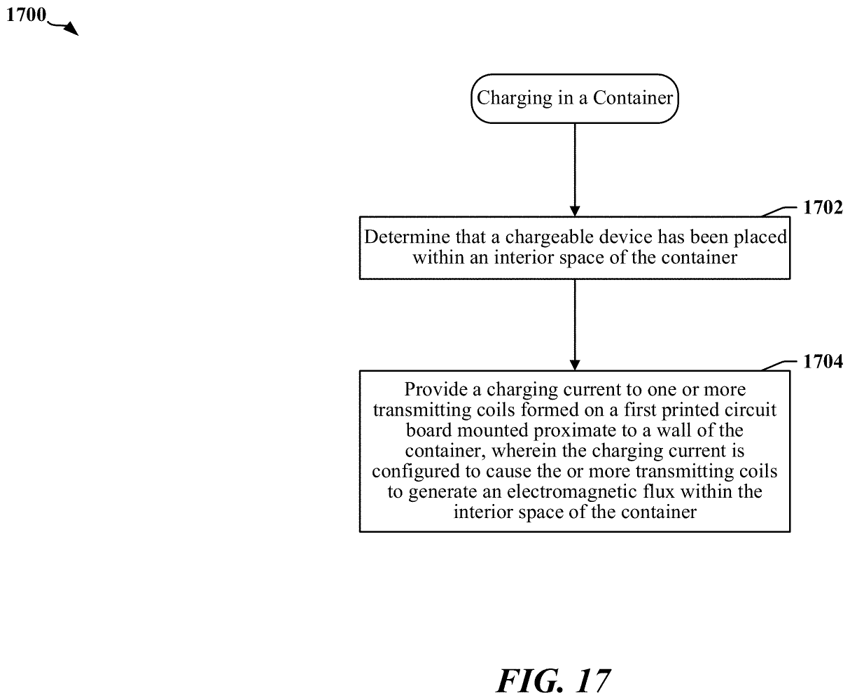

FIG. 17 is flowchart 1700 illustrating one example of a method for charging an apparatus placed in a container. The method may be performed by a controller in a power transfer circuit. At block 1702, the controller may determine that a chargeable device has been placed within an interior space of the container. At block 1704, the controller may provide a charging current to one or more transmitting coils formed on a first printed circuit board mounted proximate to a wall of the container. The charging current may be configured to cause the or more transmitting coils to generate an electromagnetic flux within the interior space of the container.

In one example, the first printed circuit board is mechanically attached to an inner surface of the wall. In one example, the first printed circuit board is mechanically attached to an outer surface of the wall. In one example, the first printed circuit board is embedded in the wall. In certain examples, a second printed circuit board mounted proximate to the wall, where the second printed circuit board has a plurality of transmitting coils arranged on at least one surface of the second printed circuit board. The plurality of transmitting coils arranged on the second printed circuit board may cooperate with the one or more transmitting coils arranged on the second printed circuit board in generating the electromagnetic flux within the partially-enclosed interior in response to the charging current received from the controller.

In certain embodiments, a second printed circuit board is mechanically coupled to the first printed circuit board by an interconnect. The interconnect may include a resilient connective member. The interconnect may include a spring. The interconnect may include a resilient connective member.

The container may be configured to hold a cup. The container may be configured as an insert for a cupholder.

### Example of a Processing Circuit

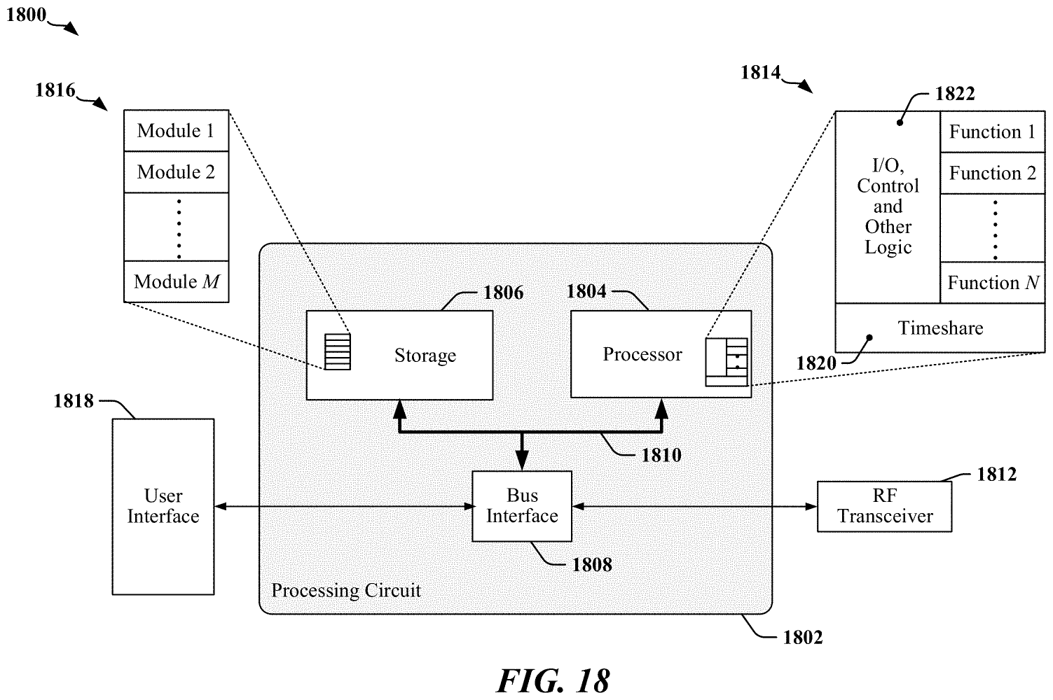

FIG. 18 illustrates an example of a hardware implementation for an apparatus 1800 that may be incorporated in a charging device or in a receiving device that enables a battery to be wirelessly charged. In some examples, the apparatus 1800 may perform one or more functions disclosed herein. In accordance with various aspects of the disclosure, an element, or any portion of an element, or any combination of elements as disclosed herein may be implemented using a processing circuit 1802. The processing circuit 1802 may include one or more processors 1804 that are controlled by some combination of hardware and software modules. Examples of processors 1804 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1804 may include specialized processors that perform specific functions, and that may be configured, augmented or controlled by one of the software modules 1816. The one or more processors 1804 may be configured through a combination of software modules 1816 loaded during initialization, and further configured by loading or unloading one or more software modules 1816 during operation.

In the illustrated example, the processing circuit 1802 may be implemented with a bus architecture, represented generally by the bus 1810. The bus 1810 may include any number of interconnecting buses and bridges depending on the specific application of the processing circuit 1802 and the overall design constraints. The bus 1810 links together various circuits including the one or more processors 1804, and storage 1806. Storage 1806 may include memory devices and mass storage devices, and may be referred to herein as computer-readable media and/or processor-readable media. The storage 1806 may include transitory storage media and/or non-transitory storage media.

The bus 1810 may also link various other circuits such as timing sources, timers, peripherals, voltage regulators, and power management circuits. A bus interface 1808 may provide an interface between the bus 1810 and one or more transceivers 1812. In one example, a transceiver 1812 may be provided to enable the apparatus 1800 to communicate with a charging or receiving device in accordance with a standards-defined protocol. Depending upon the nature of the apparatus 1800, a user interface 1818 (e.g., keypad, display, speaker, microphone, joystick) may also be provided, and may be communicatively coupled to the bus 1810 directly or through the bus interface 1808.

A processor 1804 may be responsible for managing the bus 1810 and for general processing that may include the execution of software stored in a computer-readable medium that may include the storage 1806. In this respect, the processing circuit 1802, including the processor 1804, may be used to implement any of the methods, functions and techniques disclosed herein. The storage 1806 may be used for storing data that is manipulated by the processor 1804 when executing software, and the software may be configured to implement any one of the methods disclosed herein.

One or more processors 1804 in the processing circuit 1802 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1806 or in an external computer-readable medium. The external computer-readable medium and/or storage 1806 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1806 may also include, by way of example, a carrier wave, a transmission line, and any other suitable medium for transmitting software and/or instructions that may be accessed and read by a computer. Computer-readable medium and/or the storage 1806 may reside in the processing circuit 1802, in the processor 1804, external to the processing circuit 1802, or be distributed across multiple entities including the processing circuit 1802. The computer-readable medium and/or storage 1806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1806 may maintain and/or organize software in loadable code segments, modules, applications, programs, etc., which may be referred to herein as software modules 1816. Each of the software modules 1816 may include instructions and data that, when installed or loaded on the processing circuit 1802 and executed by the one or more processors 1804, contribute to a run-time image 1814 that controls the operation of the one or more processors 1804. When executed, certain instructions may cause the processing circuit 1802 to perform functions in accordance with certain methods, algorithms and processes described herein.

Some of the software modules 1816 may be loaded during initialization of the processing circuit 1802, and these software modules 1816 may configure the processing circuit 1802 to enable performance of the various functions disclosed herein. For example, some software modules 1816 may configure internal devices and/or logic circuits 1822 of the processor 1804, and may manage access to external devices such as a transceiver 1812, the bus interface 1808, the user interface 1818, timers, mathematical coprocessors, and so on. The software modules 1816 may include a control program and/or an operating system that interacts with interrupt handlers and device drivers, and that controls access to various resources provided by the processing circuit 1802. The resources may include memory, processing time, access to a transceiver 1812, the user interface 1818, and so on.

One or more processors 1804 of the processing circuit 1802 may be multifunctional, whereby some of the software modules 1816 are loaded and configured to perform different functions or different instances of the same function. The one or more processors 1804 may additionally be adapted to manage background tasks initiated in response to inputs from the user interface 1818, the transceiver 1812, and device drivers, for example. To support the performance of multiple functions, the one or more processors 1804 may be configured to provide a multitasking environment, whereby each of a plurality of functions is implemented as a set of tasks serviced by the one or more processors 1804 as needed or desired. In one example, the multitasking environment may be implemented using a timesharing program 1820 that passes control of a processor 1804 between different tasks, whereby each task returns control of the one or more processors 1804 to the timesharing program 1820 upon completion of any outstanding operations and/or in response to an input such as an interrupt. When a task has control of the one or more processors 1804, the processing circuit is effectively specialized for the purposes addressed by the function associated with the controlling task. The timesharing program 1820 may include an operating system, a main loop that transfers control on a round-robin basis, a function that allocates control of the one or more processors 1804 in accordance with a prioritization of the functions, and/or an interrupt driven main loop that responds to external events by providing control of the one or more processors 1804 to a handling function.

In some example, the apparatus 1800 includes or operates as a power transfer or charging apparatus. The apparatus 1800 may have a first printed circuit board configured to be mounted proximate to a wall of a container that provides a partially-enclosed interior, and one or more transmitting coils arranged on at least one surface of the first printed circuit board and configured to generate an electromagnetic flux within the partially-enclosed interior in response to a charging current received from a controller. The charging current may be received when a chargeable device has been placed within the partially-enclosed interior. The container may be configured to hold a cup. The container may be configured as an insert for a cupholder.

In one example, the first printed circuit board is mechanically attached to an inner surface of the wall. In one example, the first printed circuit board is mechanically attached to an outer surface of the wall. In one example, the first printed circuit board is embedded in the wall.

In certain examples, the apparatus 1800 has a second printed circuit board mounted proximate to the wall, where the second printed circuit board has a plurality of transmitting coils arranged on at least one surface of the second printed circuit board. The plurality of transmitting coils arranged on the second printed circuit board may cooperate with the one or more transmitting coils arranged on the second printed circuit board in generating the electromagnetic flux within the partially-enclosed interior in response to the charging current received from the controller.

In certain examples, the apparatus 1800 has a second printed circuit board is mechanically coupled to the first printed circuit board by an interconnect. The interconnect may include a resilient connective member. The interconnect may include a spring. The interconnect may include a resilient connective member.

In some examples, the apparatus 1800 includes or implements wireless charging system such as the wireless charging systems illustrated in FIGS. 13-16. The wireless charging system may have a plurality of charging devices, a driver circuit and a controller. Each charging device includes one or more power transmitting coils configured to provide a magnetic flux substantially perpendicular to a charging surface of the charging device. The driver circuit may be configured to provide a charging current to one or more of the charging devices in accordance with corresponding charging configurations.

In some examples, the controller is configured using instructions and information maintained by the storage, including code that is executable by the controller. The controller is communicatively coupled to each of the plurality of charging devices and may be configured to cause at least one power transmitting coil in a first charging device to receive the charging current when a first chargeable device is placed near a first charging surface provided by the first charging device. The controller may be configured to initiate a first charging procedure by transmitting a message to a first local controller in the first charging device. The first local controller may be configured to couple the at least one power transmitting coil to the driver circuit or another charging current source in response to the message. The message may be transmitted over a serial bus operated in accordance with an I3C protocol, a CAN bus protocol or a LIN bus protocol.

In one example, the controller is further configured to determine that a second chargeable device is placed near a second charging surface provided by a second charging device, and to initiate a second charging procedure at the second charging device after determining that the second chargeable device is placed near the second charging surface. A second local controller in the second charging device may be configured to detect the second chargeable device using a ping procedure. The charging apparatus may operate or provide a distributed charging surface that includes the first charging surface and the second charging surface.

In some examples, the storage 1806 maintains instructions and information where the instructions are configured to cause the one or more processors 1804 to determine that a chargeable device has been placed within an interior space of the container, and provide a charging current to one or more transmitting coils formed on a first printed circuit board mounted proximate to a wall of the container. The charging current may be configured to cause the or more transmitting coils to generate an electromagnetic flux within the interior space of the container. The container may be configured to hold a cup. The container may be configured as an insert for a cupholder

In one example, the first printed circuit board is mechanically attached to an inner surface of the wall. In one example, the first printed circuit board is mechanically attached to an outer surface of the wall. In one example, the first printed circuit board is embedded in the wall. In certain examples, a second printed circuit board mounted proximate to the wall, where the second printed circuit board has a plurality of transmitting coils arranged on at least one surface of the second printed circuit board. The plurality of transmitting coils arranged on the second printed circuit board may cooperate with the one or more transmitting coils arranged on the second printed circuit board in generating the electromagnetic flux within the partially-enclosed interior in response to the charging current received from the controller.

In certain embodiments, a second printed circuit board is mechanically coupled to the first printed circuit board by an interconnect. The interconnect may include a resilient connective member. The interconnect may include a spring. The interconnect may include a resilient connective member.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A charging apparatus, comprising:
a first printed circuit board configured to be mounted proximate to a wall of a container that provides a partially-enclosed interior; and
one or more transmitting coils arranged on at least one surface of the first printed circuit board and configured to generate an electromagnetic flux within the partially-enclosed interior in response to a charging current received from a controller,
wherein the charging current is received when a chargeable device has been placed within the partially-enclosed interior.

2. The charging apparatus of claim 1, wherein the first printed circuit board is mechanically attached to an inner surface of the wall.

3. The charging apparatus of claim 1, wherein the first printed circuit board is mechanically attached to an outer surface of the wall.

4. The charging apparatus of claim 1, wherein the first printed circuit board is embedded in the wall.

5. The charging apparatus of claim 1, further comprising:
a second printed circuit board mounted proximate to the wall, wherein the controller is provided on the second printed circuit board; and
a plurality of transmitting coils arranged on at least one surface of the second printed circuit board,
wherein the plurality of transmitting coils arranged on the second printed circuit board cooperates with the one or more transmitting coils arranged on the second printed circuit board in generating the electromagnetic flux within the partially-enclosed interior in response to the charging current received from the controller.

6. The charging apparatus of claim 1, further comprising:
a second printed circuit board, wherein the controller is provided on the second printed circuit board; and
an interconnect configured to mechanically couple the first printed circuit board and the second printed circuit board.

7. The charging apparatus of claim 6, wherein the interconnect comprises a resilient connective member.

8. The charging apparatus of claim 6, wherein the interconnect comprises a spring.

9. The charging apparatus of claim 1, wherein the container is configured to hold a cup.

10. The charging apparatus of claim 1, wherein the container is configured as an insert for a cupholder.

11. A method for charging an apparatus placed in a container, comprising:
determining that a chargeable device has been placed within an interior space of the container; and
providing a charging current to one or more transmitting coils formed on a first printed circuit board mounted proximate to a wall of the container,
wherein the charging current is configured to cause the or more transmitting coils to generate an electromagnetic flux within the interior space of the container.

12. The method of claim 11, wherein the first printed circuit board is mechanically attached to an inner surface of the wall.

13. The method of claim 11, wherein the first printed circuit board is mechanically attached to an outer surface of the wall.

14. The method of claim 11, wherein the first printed circuit board is embedded in the wall.

15. The method of claim 11, wherein a second printed circuit board is mounted proximate to the wall and has a plurality of transmitting coils arranged on at least one surface of the second printed circuit board, and wherein the plurality of transmitting coils arranged on the second printed circuit board cooperates with the one or more transmitting coils arranged on the second printed circuit board in generating the electromagnetic flux within the interior space of the container in response to the charging current.

16. The method of claim 11, wherein a second printed circuit board is mechanically coupled to the first printed circuit board by an interconnect.

17. The method of claim 16, wherein the interconnect comprises a resilient connective member.

18. The method of claim 16, wherein the interconnect comprises a spring.

19. The method of claim 11, wherein the container is configured to hold a cup.

20. The method of claim 11, wherein the container is configured as an insert for a cupholder.

21. A wireless charging system, comprising:
a plurality of charging devices, each charging devices including one or more power transmitting coils configured to provide a magnetic flux substantially perpendicular to a charging surface of the each charging device;
a driver circuit configured to provide a charging current; and
a controller coupled to each of the plurality of charging devices and configured to cause at least one power transmitting coil in a first charging device to receive the charging current when a first chargeable device is placed near a first charging surface provided by the first charging device.

22. The wireless charging system of claim 21, wherein the controller is configured to initiate a first charging procedure by transmitting a message to a first local controller in the first charging device, wherein the first local controller is configured to couple the at least one power transmitting coil to the driver circuit in response to the message.

23. The wireless charging system of claim 22, wherein the message is transmitted over a serial bus operated in accordance with an Improved Inter-Integrated Circuit (I3C) protocol, a Controller Area Network (CAN) protocol or a Local Interconnected Network (LIN) protocol.

24. The wireless charging system of claim 21, wherein the controller is further configured to:
determine that a second chargeable device is placed near a second charging surface provided by a second charging device; and
initiate a second charging procedure at the second charging device after determining that the second chargeable device is placed near the second charging surface.

25. The wireless charging system of claim 24, wherein a second local controller in the second charging device is configured to detect the second chargeable device using a ping procedure.

26. The wireless charging system of claim 24, wherein the wireless charging system operates a distributed charging surface that includes the first charging surface and the second charging surface.
